(19) United States
(12) Patent Application Publication
(10) Pub. No.: US 2012/0019451 A1
(43) Pub. Date: Jan. 26, 2012

(54) TOUCH PANEL AND TOUCH DISPLAY DEVICE USING SAME

(75) Inventors: GA-LANE CHEN, Santa Clara, CA (US); TAI-CHERNG YU, Tu-Cheng (TW); CHIH-CHEN LAI, Tu-Cheng (TW)

(73) Assignee: HON HAI PRECISION INDUSTRY CO., LTD., Tu-Cheng (TW)

(21) Appl. No.: 12/888,404

(22) Filed: Sep. 22, 2010

(30) Foreign Application Priority Data
Jul. 23, 2010 (TW) 99124442

(51) Int. Cl. G06F 3/041

(52) U.S. Cl. 345/173; 977/952

(57) ABSTRACT

A touch panel includes a first electrically conductive substrate, a second electrically conductive substrate; and a plurality of insulators located between the first electrically conductive substrate and the second electrically conductive substrate. The second electrically conductive substrate includes a first carbon nanotube film facing the first electrically conductive substrate, and a second carbon nanotube film exposed outside the touch panel.

### BACKGROUND

1. Technical Field

The present disclosure relates to touch panels, and particularly to a touch panel having carbon nanotube films, and a touch display device using the touch panel.

2. Description of Related Art

A typical touch panel includes a first electrically conductive substrate, a second electrically conductive substrate, and a number of insulators located between the first and second substrates. One of the first and second substrates faces outside and flexibly electrically contacts the other if a pressure is applied thereon.

However, the exposed substrate may be easily damaged and wear out too easily over time.

What is needed, therefore, is a touch panel and a touch display device using same, which can overcome the above shortcomings.

### BRIEF DESCRIPTION OF THE DRAWINGS

Many aspects of the present touch panel and touch display device can be better understood with reference to the following drawings. The components in the drawings are not necessarily drawn to scale, the emphasis instead being placed upon clearly illustrating the principles of the present touch panel and touch display device. Moreover, in the drawings, like reference numerals designate corresponding parts throughout the several views.

FIG. 1 is a schematic view of a touch panel in accordance with a first embodiment, the touch panel including a first electrically conductive substrate and a second electrically conductive substrate.

FIG. 2 is an enlarged view of the circled portion II of the second electrically conductive substrate shown in FIG. 1.

FIG. 3 is an enlarged view of a second electrically conductive substrate in accordance with a second embodiment.

FIG. 4 is an enlarged view of a second electrically conductive substrate in accordance with a third embodiment.

FIG. 5 shows a touch display device in accordance with a fourth embodiment.

### DETAILED DESCRIPTION

Embodiments of the present touch panel and touch display device will now be described in detail below and with reference to the drawings.

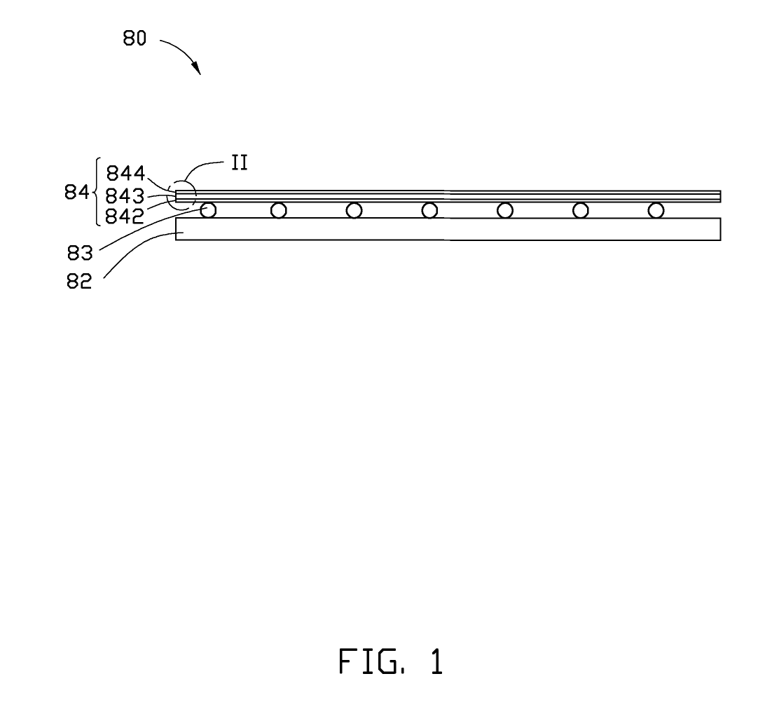

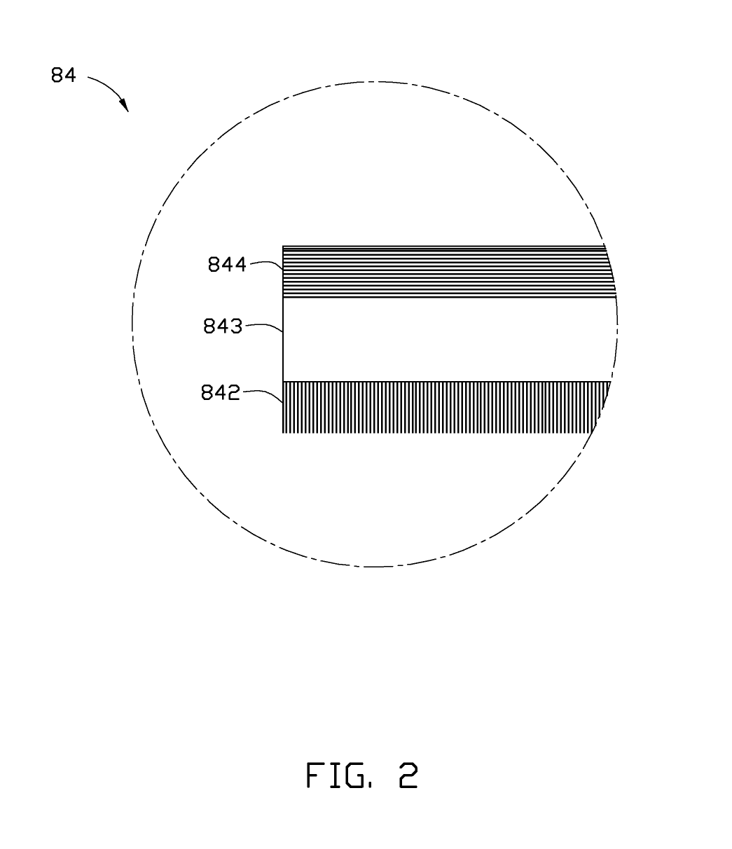

Referring to FIGS. 1 and 2, a touch panel 80 in accordance with a first embodiment, is provided. The touch panel 80 includes a first electrically conductive substrate 82, a second electrically conductive substrate 84, and a number of insulators 83 sandwiched between the first substrate 82 and the second substrate 84. Too improve ruggedness and other properties of the touch panel 80, carbon nanotube films described below are provided.

The first substrate 82 is made of a transparent electrically conductive material, e.g., indium tin oxide. The insulators 83 can be formed into spheres and made of transparent dielectric material such as plastic to help keep a separation between the first and second substrates 82, 84 when no pressure from a touch is applied.

The second substrate 84 is flexible. The second substrate 84 includes a first carbon nanotube film 842 that faces the first substrate 82 and is in contact with the insulators 83, and a second carbon nanotube film 844 exposed outside the touch panel 80. In the present embodiment, the second electrically conductive substrate 84 further includes a flexible transparent layer 843, the first carbon nanotube film 842 is formed on a bottom surface of the flexible transparent layer 843, and the second carbon nanotube film 844 is formed on a top surface of the flexible transparent layer 843.

The carbon nanotubes of the first carbon nanotube film 842 are in an array, and a lengthwise direction of each of the carbon nanotubes is substantially perpendicular to the bottom surface of the flexible transparent layer 843. In actual production, the flexible transparent layer 843 can serve as a substrate for growing the carbon nanotubes on the bottom surface thereof, thus the carbon nanotubes are substantially perpendicular to the bottom surface. The carbon nanotubes in the second carbon nanotube film 844 are substantially parallel with the top surface of the flexible transparent layer 843. The carbon nanotubes herein and after may be referred to as carbon nanotube sections.

Carbon nanotubes have electrical conductivity along the lengthwise directions thereof. The carbon nanotubes of the first carbon nanotube film 842 have quick response time and allow for precisely identifying location of a touched portion if a pressure is applied on the second substrate 84 causing it to electrically contact the first substrate 82.

The carbon nanotubes of the second carbon nanotube film 844 each have a diameter in a range about 10 nm to 50 nm. Within this diameter range, the carbon nanotubes of the second carbon nanotube film 844 allow sufficient flexibility of the film while retaining a rugged characteristic that can better withstand repeated use than previous touch screens.

The carbon nanotubes of the first carbon nanotube film 842 and the second carbon nanotube film 844 can be single-walled carbon nanotubes for better light penetrability. Thickness of the second substrate 84 can be made according to a desire level of light penetrability.

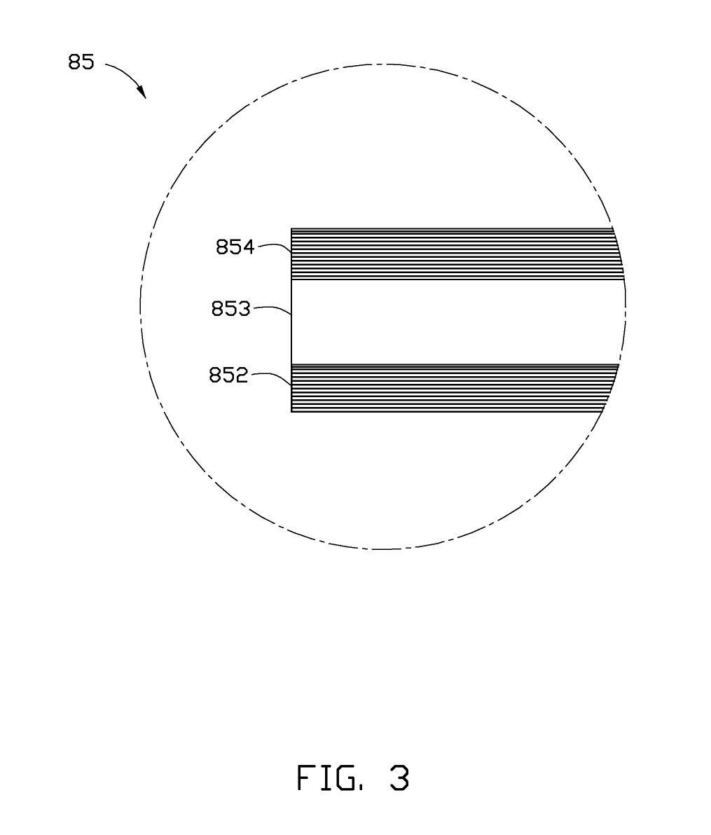

Referring to FIG. 3, a second electrically conductive substrate 85 of a touch panel in accordance with a second embodiment, is provided. The second substrate 85 includes a flexible transparent layer 853, a first carbon nanotube film 852 formed on the bottom surface of the flexible transparent layer 853, and a second carbon nanotube film 854 formed on the top surface of the flexible transparent layer 853. The carbon nanotubes of both the first and second carbon nanotube films 852, 854 are substantially parallel with the flexible transparent layer 853. Because the carbon nanotubes also have electrically conductivity along a radial direction, the first carbon nanotube film 852 can also be used to electrically conduct the first substrate of the touch panel (not shown).

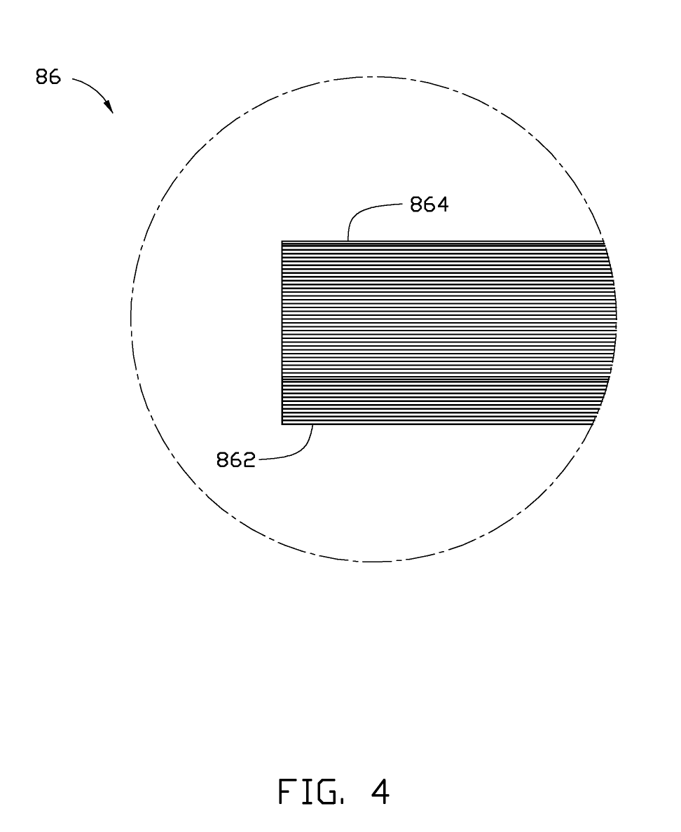

Referring to FIG. 4, a second electrically conductive substrate 86 of a touch panel in accordance with a third embodiment, is provided. The second substrate 86 is comprised of a number of carbon nanotube films stacked one on another. The second substrate 86 has a thickness greater than 100 microns and is still flexible. The second substrate 86 also includes a first carbon nanotube film 862 at the inner side, and a second carbon nanotube film 864 at the outer side. In the present embodiment, the carbon nanotubes of the carbon nanotube films are substantially parallel with the first substrate of the touch panel (not shown).

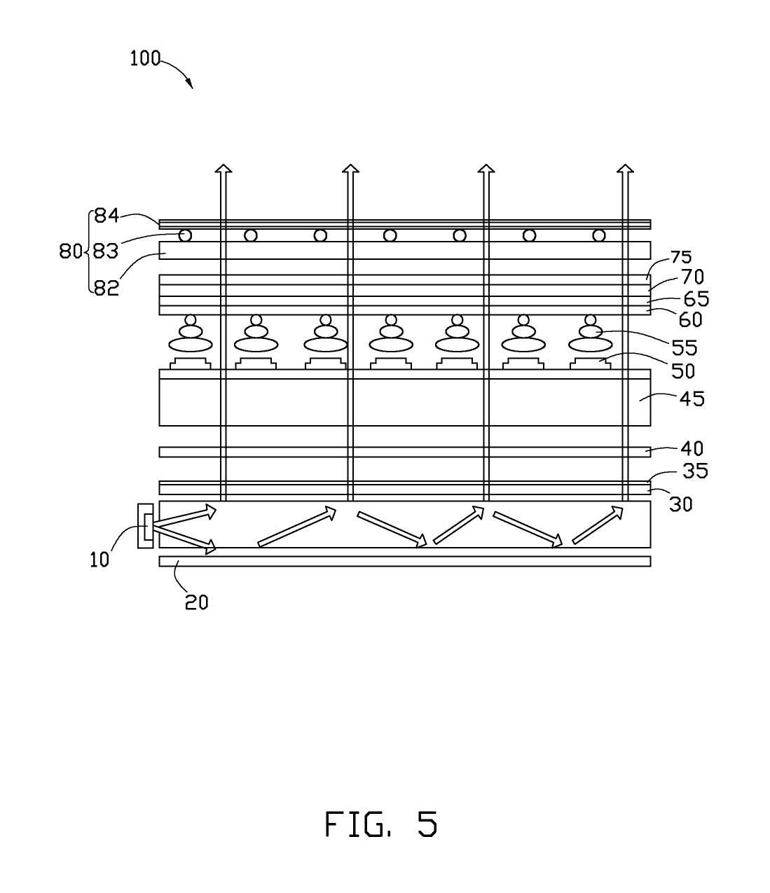

Referring to FIG. 5, a touch display device 100 in accordance with a fourth embodiment, is provided. The touch display device 100 includes a display panel assembly and a touch panel 80 mounted at a front side thereof. The display panel assembly includes in sequence a light emitting element 10, a light reflecting plate 20, a light diffusing plate 30, a brightness enhancement film 35 formed on a light output surface of the light diffusing plate 30, a lower polarizing plate 40, a lower glass substrate 45, a thin-film transistor module 50, a liquid crystal layer 55, a common electrode 60, a filter 65, an upper glass substrate 70 and an upper polarizing plate 75. The upper polarizing plate 75 is adjacent to the touch panel 80.

The light emitting element 10 has a multiple quantum well structure. The multiple quantum well structure includes two different semiconductor materials staggered and stacked one on another. The light reflecting plate 20 is configured to reflect light to the light diffusing plate 30. The light diffusing plate 30 has scattering dots formed thereon to allow light uniform. The cooperation of the lower polarizing plate 40 and the upper polarizing plate 75 can adjust light output. The liquid crystal layer 55 acts as a light switch based on voltages applied thereon. The thin-film transistor module 50 controls the liquid crystal layer 55 by applying the different voltages thereon.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A touch panel, comprising:
a first electrically conductive substrate;
a second electrically conductive substrate; and
a plurality of insulators located between the first electrically conductive substrate and the second electrically conductive substrate, wherein the second electrically conductive substrate comprises a first carbon nanotube film facing the first electrically conductive substrate, and a second carbon nanotube film exposed outside the touch panel.

2. The touch panel of claim 1, wherein the second electrically conductive substrate further comprises a flexible transparent layer, the first carbon nanotube film is formed on a bottom surface of the flexible transparent layer, the second carbon nanotube film is formed on a top surface of the flexible transparent layer.

3. The touch panel of claim 2, wherein the first carbon nanotube film comprises a plurality of carbon nanotubes substantially perpendicular to the bottom surface, and the second carbon nanotube film comprises a plurality of carbon nanotubes substantially parallel with the top surface.

4. The touch panel of claim 2, wherein each of the first and second carbon nanotube films comprises a plurality of carbon nanotubes substantially parallel with the flexible transparent layer.

5. The touch panel of claim 1, wherein the second electrically conductive substrate is comprised of a plurality of carbon nanotube films stacked one on another, each of the first and second carbon nanotube films comprises a plurality of carbon nanotubes substantially parallel with the first electrically conductive substrate.

6. A touch display device, comprising:
a display panel assembly; and
a touch panel mounted on a front side of the display panel assembly, the touch panel comprising:
a first electrically conductive substrate;
a second electrically conductive substrate; and
a plurality of insulators located between the first electrically conductive substrate and the second electrically conductive substrate, wherein the second electrically conductive substrate comprises a first carbon nanotube film facing the first electrically conductive substrate, and a second carbon nanotube film exposed outside the touch panel.

7. The touch display device of claim 6, wherein the display panel assembly comprises a light emitting element having a multiple quantum well structure.

8. The touch display device of claim 6, wherein the second electrically conductive substrate further comprises a flexible transparent layer, the first carbon nanotube film is formed on a bottom surface of the flexible transparent layer, the second carbon nanotube film is formed on a top surface of the flexible transparent layer.

9. The touch display device of claim 8, wherein the first carbon nanotube film comprises a plurality of carbon nanotubes substantially perpendicular to the bottom surface, and the second carbon nanotube film comprises a plurality of carbon nanotubes substantially parallel with the top surface.

10. The touch display device of claim 8, wherein each of the first and second carbon nanotube films comprises a plurality of carbon nanotubes substantially parallel with the flexible transparent layer.

11. The touch display device of claim 6, wherein the second electrically conductive substrate is comprised of a plurality of carbon nanotube films stacked one on another, and each of the first and second carbon nanotube films comprises a plurality of carbon nanotubes substantially parallel with the first electrically conductive substrate.

12. A touch panel comprising:
a first electrically conductive substrate;
a second electrically conductive substrate comprising a flexible transparent layer, a first carbon nanotube film and a second carbon nanotube film, the first and second carbon nanotube film formed on opposite sides of the transparent layer, the first carbon nanotube film including a plurality of aligned carbon nanotubes, the second carbon nanotube film including a plurality of aligned carbon nanotubes parallel to a main plane of the transparent layer; and
a plurality of insulators sandwiched between the first electrically conductive substrate and the first carbon nanotube film.
